(19) United States
(12) Patent Application Publication
(10) Pub. No.: US 2010/0198694 A1
(43) Pub. Date: Aug. 5, 2010

(54) Advertisement Slot Configuration

(75) Inventor: Shanmugavelayutham Muthukrishnan, New York, NY (US)

Correspondence Address: FISH & RICHARDSON P.C., PO BOX 1022, MINNEAPOLIS, MN, 55440-1022, US

(73) Assignee: Google Inc., Mountain View, CA (US)

(21) Appl. No.: 12/363,487

(22) Filed: Jan. 30, 2009

(51) Int. Cl. G06Q 30/00

(52) U.S. Cl. 705/14.71

(57) ABSTRACT

A slot configuration that defines a manner in which content items are presented in slots in a publishers property are selected based on bids that are received from content providers. The bids represent a relative value of the slots in the slot configurations to the content providers. An auction subsystem identifies an optimal slot configuration as the slot configuration that optimizes a value of the slots to the content providers to which the slots are allocated. The slots in the optimal slot configuration are allocated to content providers based on the providers' bids. The price paid by each provider for allocation of a slot is based on a minimum pay property for the provider. The minimum pay property is the minimum price that the provider must bid to maintain the allocation of slots in the optimal slot configuration.

### BACKGROUND

This document relates to information presentation.

The Internet has enabled access to a wide variety of content items, e.g., video and/or audio files, webpages for particular subjects, news articles, etc. Such access to these content items has likewise enabled opportunities for targeted advertising. For example, content items of particular interest to a user can be identified by a search engine in response to a user query. The query can include one or more search terms, and the search engine can identify and, optionally, rank the content items based on the search terms in the query and present the content items to the user (e.g., according to the rank). This query can also be an indicator of the type of information of interest to the user. By comparing the user query to a list of keywords specified by an advertiser, it is possible to provide targeted advertisements to the user, for example, in advertisement slots that are defined in a webpage.

Another form of online advertising is advertisement syndication, which allows advertisers to extend their marketing reach by distributing advertisements to additional partners. For example, third party online publishers can place an advertiser's text or image advertisements on web pages that have content related to the advertisement. As the users are likely interested in the particular content on the publisher webpage, they are also likely to be interested in the product or service featured in the advertisement. Accordingly, such targeted advertisement placement can help drive online customers to the advertiser's website.

In some situations, advertisements can be selected for presentation in advertisement slots defined in a webpage based on an auction of the advertisement slots. For example, bidders can submit bids for n advertisement slots that are available on the webpage. In turn the auction can allocate the n advertisement slots to the bidders from which a highest n bids are received.

The configuration of advertisement slots are typically fixed by the publishers (e.g., of the webpages). The publishers typically select the advertisement slot configuration without direct input from the bidders that compete in the auction for the advertisement slots. Bidders that compete in the auction for the advertisement slots may place a higher value on the advertisement slots if the advertisement slots were presented in a configuration different from that selected by the publisher.

### SUMMARY

In general, one aspect of the subject matter described in this specification can be implemented in methods that include the actions identifying a plurality of slot configurations for a publication provided by a publisher, each slot configuration comprising one or more slots; receiving a plurality of bids from a plurality of bidders for each slot configuration, each bid specifying a maximum amount that a bidder will pay for allocation of a slot in the corresponding slot configuration; determining a cumulative value for each slot configuration based on the plurality of bids; selecting the slot configuration having a maximum cumulative value as the optimal slot configuration; and allocating the one or more slots in the optimal slot configuration to the bidders based on the plurality of bids for the optimal slot configuration. Other embodiments of this aspect include corresponding systems, apparatus, and computer program products.

These and other implementations can optionally include one or more of the following features. The slot can be an advertisement slot and a slot configuration can be an advertisement slot configuration. Each advertisement slot configuration can define an advertisement type that is eligible to have a corresponding bid for the advertisement slots. Each slot configuration can define a unique number of slots. Each slot configuration can define a unique orientation of slots. The action determining the cumulative value for each slot configuration can include for each slot configuration the actions identifying a number of slots available for allocation in the slot configuration; identifying a number of highest bids for the slot configuration based on the number of slots; and summing the number of highest bids for the slot configuration. The number of highest bids can be a number of slots available. The methods can further include the action determining a price for the one or more slots based on the plurality of bids for the slot configuration. The action determining a price for the one or more slots can include the action determining a minimum pay property for each bidder that is allocated each of the one or more slots, the minimum pay property being a minimum price that the bidder must bid to maintain the allocation of the one or more slots to the bidders. The methods can include the action providing content to the publisher for presentation in the one or more slots in the optimal slot configuration. The content provided to the publisher can include advertisements for bidders that provided a predefined number of highest bids, the predefined number being based on a number of slots available in the optimal slot configuration.

Particular embodiments of the subject matter described in this specification can be implemented so as to realize one or more of the following advantages. An optimal advertisement slot configuration can be selected for a webpage by bidders for advertisement slots in the webpage. A value to advertisers that are allocated advertisement slots on a webpage can be maximized by configuring advertisement slots on a webpage based on the optimal advertisement slot configuration. Bidders select the advertisement configuration for a webpage based on the bids that they provide for the advertisement slots in the webpage. The price paid by advertisers in the optimal advertisement configuration is set to the lowest bid that the advertiser could have provided that maintains the allocation of the advertisement slots to advertisers in the optimal advertisement slot allocation if all other bids were fixed and known to the advertiser.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example online environment.

FIGS. 2A and 2B are illustrations of an example webpage rendered according to two different advertisement slot configurations.

FIG. 3A is a flow chart of an example process for allocating advertisement slots in an optimal slot configuration.

FIG. 3B is a flow chart of an example process of determining the cumulative value for each slot configuration

FIG. 4 is block diagram of an example computer system that can be used to facilitate allocation of advertisement slots in an optimal advertisement slot configuration.

Like reference numbers and designations in the various drawings indicate like elements.

### DETAILED DESCRIPTION

An auction subsystem identifies an optimal slot configuration based on bids received from content providers. The optimal slot configuration is a slot configuration that optimizes one or more properties of a content configuration. In some implementations, the optimal slot configuration is the slot configuration that maximizes a cumulative value of the slots to the content providers that are allocated the slots. The auction subsystem identifies one or more configurations in which slots can be presented. For each configuration, the auction subsystem receives bids that specify maximum amounts that content providers will pay for allocation of a slot presented in the configuration.

Based on the received bids, the auction subsystem identifies the slot configuration that maximizes a value of the slots. For example, the auction subsystem can determine the maximum value of the slots based on the sum of the n highest bids for each slot configuration, where n is the number of available slots in the configuration. In turn, the auction subsystem can define the slot configuration according to the identified slot configuration.

Once a slot configuration is selected, the auction subsystem can allocate the n slots to the n highest bidders. The price paid by each content provider for each slot can be based on a minimum pay property for the content provider that is allocated the slot. The minimum pay property is the minimum price that a content provider must bid to maintain the allocation of slots to the content providers in the optimal configuration.

While reference is made throughout this document to identifying an optimal advertisement slot configuration for a webpage, the methods and systems described below for identifying an optimal advertisement slot configuration can be implemented for other content environments (e.g., configurations in print media or time slot configurations in television or radio media).

### §1.0 Advertisement Publishing And Tracking

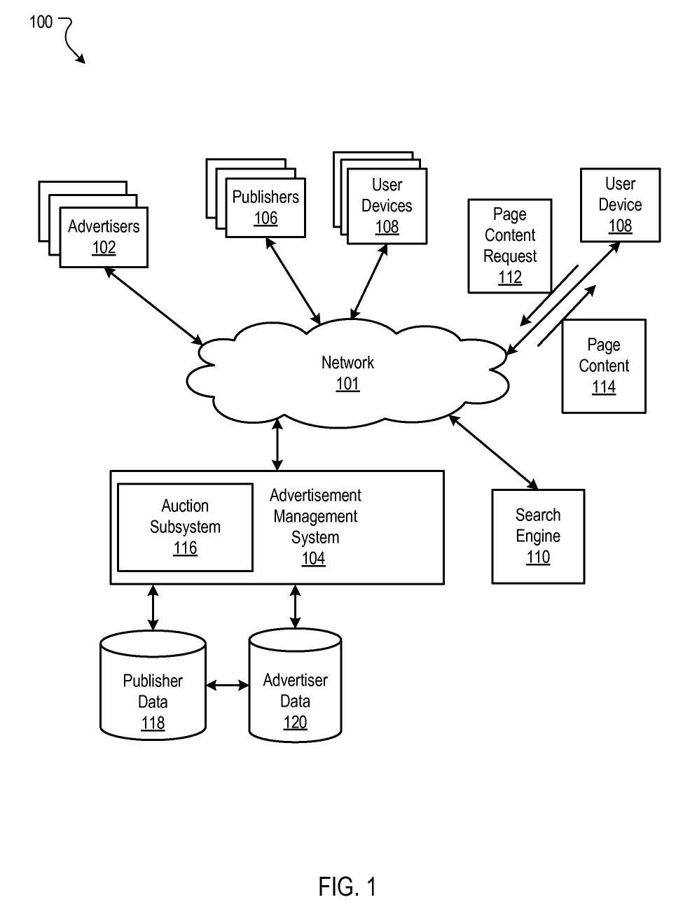

FIG. 1 is a block diagram of an example online environment 100. The online environment 100 can facilitate the identification and serving of content items, e.g., webpages, advertisements, etc., to users. A computer network 101, such as a local area network (LAN), wide area network (WAN), the Internet, or a combination thereof, connects advertisers 102, an advertisement management system 104, publishers 106, user devices 108, and a search engine 110. The online environment 100 may include many thousands of advertisers 102, publishers 106 and user devices 108.

In some implementations, one or more advertisers 102 can directly, or indirectly, enter, maintain, and track advertisement information in the advertising management system 104. The advertisement information can include advertisements that the advertiser 102 has provided for presentation on publisher webpages. The advertisements can be in the form of graphical advertisements, such as banner advertisements, text only advertisements, image advertisements, audio advertisements, video advertisements, advertisements combining one of more of any of such components, etc., or any other type of electronic advertisement document. The advertisements may also include embedded information, such as links, meta-information, and/or machine executable instructions, such as HTML or JavaScript™. The advertisement information and corresponding advertisements can be stored in an advertiser data store 120 that is coupled to the advertisement management system 104.

A user device 108 can submit a page content request 112 to a publisher 106 or the search engine 110. In some implementations, page content 114 can be provided to the user device 108 in response to the request 112. The page content 114 can include advertisements provided by the advertisement management system 104, or can include executable instructions, e.g., JavaScript™, that can be executed at the user device 108 to request advertisements from the advertisement management system 104. Example user devices 108 include personal computers, mobile communication devices, television set-top boxes, etc.

Requests for advertisements can also be received from the publishers 106. For example, one or more publishers 106 can submit advertisement requests for one or more advertisements to the advertisement management system 104. The system 104 responds by sending the advertisements to the requesting publisher 106 for placement in an advertisement slot that is presented on one or more of the publisher's web properties (e.g., websites and other network-distributed content). The advertisements can include embedded links to landing pages (e.g., pages on the advertisers' 102 websites) that a user device 108 is directed to when a user selects an advertisement that is presented on the publisher's web property. The requests for advertisements can also include content request information. This content request information can include the content itself (e.g., page or other content document), a category corresponding to the content or the content request (e.g., arts, business, computers, arts-movies, arts-music, etc.), part or all of the content request, content age, content type (e.g., text, graphics, video, audio, mixed media, etc.), geo-location information, etc.

In some implementations, a publisher 106 can combine the requested content with one or more of the advertisements provided by the system 104. This combined requested content and advertisements can be sent to the user device 108 that requested the content as page content 114 for presentation in a viewer (e.g., a browser or other content display system). The publisher 106 can transmit information about the advertisements back to the advertisement management system 104, including information describing how, when, and/or where the advertisements are to be rendered (e.g., in HTML or JavaScript™).

The configuration in which the advertisements are presented with the requested content provided to the user device is referred to as an advertisement slot configuration. The advertisement slot configuration defines a unique number and/or unique orientation of advertisement slots in the webpage. The advertisement slot configuration can also define an advertisement type that is eligible to have a corresponding bid for the advertisement slots. A publisher 106 can define the advertisement slot configuration for each of the publisher's webpages. In turn, the requested advertisements can be presented in the advertisement slots defined by the advertisement slot configuration.

Publishers 106 can include general content servers that receive requests for content (e.g., articles, discussion threads, music, video, graphics, search results, webpage listings, information feeds, etc.), and retrieve the requested content in response to the request. For example, content servers related news content providers, retailers, independent blogs, social network sites, or any other entity that provides content over the network 101 can be a publisher 106.

Advertisements can also be provided using the search engine 110. The search engine 110 can receive search queries. In response, the search engine 110 accesses an index of documents (e.g., from an index of webpages) and generates search results that identify documents that are responsive to the query. An exemplary search engine 110 is described in the article S. Brin and L. Page, “The Anatomy of a Large-Scale Hypertextual Search Engine,” Seventh International World Wide Web Conference, Brisbane, Australia and in U.S. Pat. No. 6,285,999. A Search result can include, for example, a webpage title, a snippet of text extracted from the webpage, and a hypertext link to those webpage. The search results may be grouped into a predetermined number of (e.g., ten) search results.

The advertisers 102, user devices 108, and/or the search engine 110 can also provide usage information to the advertisement management system 104. This usage information can include measured or observed user behavior related to advertisements that have been served, such as, for example, whether or not a conversion or a selection related to an advertisement has occurred. The system 104 performs financial transactions, such as crediting the publishers 106 and charging the advertisers 102 based on the usage information. Such usage information can also be processed to measure performance metrics, such as an impression count, a click-through-rate (“CTR”), conversion rate, etc.

An impression can occurs when an advertisement is presented to a user. An impression count can tracks the number of times that an advertisement has been presented to a user. For example, when a user device 108 requests a webpage, multiple advertisements can be provided to the user device 108 with the webpage. Each of the advertisements that are provided with the webpage can have an impression counter incremented because an advertisement impression has occurred. The total number of times that the advertisement has been provided to a user device can be tracked with the impression counter and stored as the impression count.

A click-through occurs when a user of a user device 108, selects or “clicks” on a link to a content item returned by the publisher 106 or the advertising management system 104. The CTR is a performance metric that is obtained by dividing the number of users that clicked on the content item, e.g., a link to a landing page, an advertisement, or a search result, by the number of times the content item was delivered to user devices 108.

A conversion occurs when a user consummates a transaction related to a previously served advertisement. What constitutes a conversion may vary from case to case and can be determined in a variety of ways. For example, a conversion may occur when a user clicks on an advertisement, is referred to the advertiser's webpage, and consummates a purchase there before leaving that webpage. Other actions that constitute a conversion can also be used.

### §2.0 Advertisement Slot Configuration

As discussed above, publisher's webpages can include advertisement slots in which advertisements can be presented. The configuration in which advertisement slots are presented on a webpage is generally determined by the publisher 106. For example, publishers 106 may define a single static configuration of advertisement slots in which advertisements can be presented each time the webpage is provided to user devices 108. Alternatively, publishers 106 can define two or more advertisement slot configurations that can be dynamically selected for presenting advertisements on a webpage when the webpage is provided to a user device 108.

The discussion that follows refers to advertisement slot configurations that differ based on a different number so advertisement slots being presented, however, advertisement slot configurations can differ in other ways (e.g., different advertisement orientations or alignments) as well.

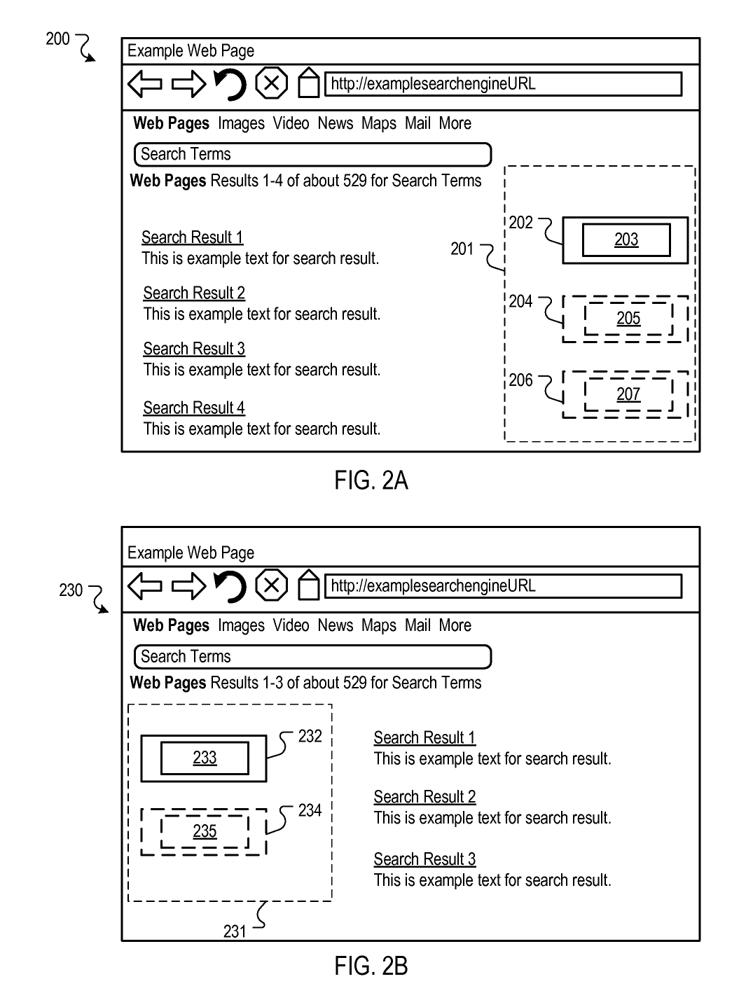

FIGS. 2A and 2B are illustrations of an example webpage rendered according to different advertisement slot configurations. The example web page 200 is rendered having advertisement slots configured in an example advertisement slot configuration within a display area 201. The display area 201 includes three advertisement slots 202, 204 and 206 in which three advertisements 203, 205 and 207 can be presented. The advertisement slots 202, 204 and 206 are aligned vertically on the right hand side of the example webpage 200. The advertisement slots 204 and 206 are represented by dashed lines to indicate that advertisements 203 and 205 can be selectively displayed in these advertisement slots. For example, the publisher 106 can determine whether a single advertisement 203 is presented in advertisement slot 202, or whether an advertisement 203 and/or 205 is also presented in advertisement slots 204 and/or 206. Thus, three or more advertisement slot configurations may exist for the advertisement slots 202, 204 and 206 based on the selective presentation of one, two or three advertisements in the advertisement slots 202, 204 and/or 206 on the example webpage 200. Additional advertisement slot configurations can also be defined based on an orientation of the advertisement slots in the webpage.

In some implementations, a publisher 106 can select the advertisement slot configurations within display area 201 and the advertisement slot configurations within the display area 231 as alternative advertisement slot configurations of a single webpage. The example webpage 230 of FIG. 2B is rendered according to advertisement slot configuration in display area 231 that includes up to two advertisement slots 232 and 234 in which two advertisements 233 and/or 235 can be presented. The advertisement slots 232 and 234 are located on the left hand side of the webpage 230 and aligned vertically.

When a publisher 106 defines advertisement slot configurations for a single webpage, the publisher 106 can specify an order or iterative pattern in which the advertisement slot configurations are used. The publisher 106 can specify rules for determining which advertisement slot configuration is used in response to each request for the webpage.

For example, the publisher 106 may specify that advertisements be presented on the webpage according to each of the advertisement slot configurations an equal percentage of the total webpage presentations. Alternatively, the publisher 106 can specify periods of time (e.g., days of the week, times of the day or months of the year) in which each advertisement slot configuration is used. In turn, each of the advertisement slots in the advertisement slot configuration used can be auctioned based on bids received from advertisers 102. However, the optimal advertisement slot configuration may not be selected if the cumulative value of the advertisement slot configurations is not known. Thus, the advertising revenue derived by the publisher may not be optimized for the webpage. Similarly, the value derived by advertisers 102 that are allocated an advertisement slot on the webpage may not be optimized.

### §2.1 Optimal Advertisement Slot Configuration Identification

An auction subsystem 116 of an advertisement management system 104 can identify an optimal advertisement slot configuration based on bids that are received from advertisers 102. In some implementations, the optimal advertisement slot configuration is the advertisement slot configuration that maximizes the cumulative value of the advertisement slots to the advertisers 102 that are allocated the advertisement slots. The value of the advertisement slots available in each advertisement slot configuration can be determined based on bids that are received from advertisers 102 for the advertisement slots in each of the respective advertisement slot configurations, as discussed below.

The advertisement management system 104 can receive advertisement slot configuration data from a publisher 106 that defines one or more advertisement slot configurations for the publisher's webpage. The advertisement slot configuration data can define a number of available advertisement slots, the size of each available advertisement slot and the location of each available advertisement slot, as shown in FIGS. 2A and 2B. The advertisement management system 104 can store the advertisement slot configuration data in a publisher data store 118.

An advertiser 102 can provide the advertisement management system 104 data that can be used to identify target webpages on which the advertiser 102 can place advertisements. For example, an advertiser 102 can access the advertisement management system 104 and enter keywords that can be used to target advertisements to a webpage.

An advertiser 102 can also submit bid data to the advertisement management system 104 that specify maximum amounts that the advertiser 102 is willing to pay for an advertisement slot. The bid data can also specify advertisement slot configurations for which the bid is valid. For example, bid data can specify that the bid is only valid when fewer than three advertisements are presented in an advertisement slot configuration. Bid data can also specify that a bid is only valid when the advertisement slot configuration includes a banner ad across the top of a web page. The bids received from advertisers 102 can be stored and indexed in the advertiser data store 120. The advertisement slots in an advertisement slot configuration are allocated to advertisers 102 based on the bid data that includes bids that are valid for the advertisement slot configuration.

In some implementations, advertisers can bid on particular advertisement slot configurations prior to an auction. The advertisement management system 104 can receive the advertisement slot configuration data from publishers 106 and can store and index the advertisement slot configuration data in a publisher data store 118. The advertisers 102 can search the publisher webpages by providing advertising queries to the advertisement management system 104. Example advertising queries include keywords, demographics parameters, and topic parameters.

The advertisement management system 104 accesses the publisher data store 118 to identify target webpages that satisfy the advertising queries provided by the advertiser 102. For each target webpage that is identified, the advertisement management system 104 can provide the advertiser 102 information identifying different advertisement slot configurations that are available for each of the target webpages and other information (e.g., demographic information, performance information, etc.) related to the target webpage. Each advertiser 102 can then selectively provide independent bids for advertisement slots in the advertisement slot configurations. For example, if a target webpage can be configured in the configuration of example webpage 200 or example webpage 230, the advertisement management system 104 can provide information identifying these two advertisement slot configurations to the advertiser 102 and receive a bid for an advertisement slot in any of these two advertisement slot configurations.

In some implementations, the advertisement management system 104 can provide the advertisement slot configuration data for each target webpage to the advertiser 102 in the form of text that describes the advertisement slot configurations. For example, the advertisement management system 104 can provide text that describes the advertisement slot configuration in display area 201 as three advertisement slots arranged vertically on the right hand side of the webpage. Similarly, the advertisement management system 104 can provide text describing the number and orientation of the advertisement slots in the advertisement slot configurations in display area 231. Alternatively, the advertisement management system 104 can use the advertisement slot configuration data to create webpage templates that are similar in appearance to the example webpages 200 and 230 of FIGS. 2A and 2B and provide the templates to the advertiser 102.

The auction subsystem 116 receives bids from an advertiser 102 for advertisement slots in one or more of the advertisement slot configurations. The bids are received either directly from the advertiser 102 or through the advertisement management system 104. The bids specify a maximum price that the advertiser 102 is willing to pay for its advertisement to be presented in an advertisement slot on the webpage. Each advertiser 102 can provide a separate bid for advertisement slots in each of the advertisement slot configurations. The bids received from advertisers 102 can be stored in the advertiser data store 120.

For example, four particular advertisers A, B, C and D may be interested in having their respective advertisements presented on a webpage that can be configured in accordance with the advertisement configuration 201 of FIG. 2A. Therefore, each of the advertisers A, B, C and D can provide, for example, a separate cost per thousand impression (“CPM”) bid for an advertisement slot in each of a one slot configuration, two slot configuration and three slot configuration in the display area 201, as provided in Table 1.

TABLE 1

| | One Slot | Two Slot | Three Slot |
|---|---|---|---|
| | Configuration | Configuration | Configuration |
| Advertiser A | $152 | $100 | $50 |
| Advertiser B | $0 | $50 | $0 |
| Advertiser C | $30 | $40 | $15 |
| Advertiser D | $22 | $30 | $10 |

The amount that each advertiser bids for an advertisement slot in each of the available advertisement slot configurations can represent a measure of the relative value of the advertisement slots in the respective advertisement slot configurations. For example, advertiser A is willing to pay $100 CPM for an advertisement slot when one or two slots are presented, but is only willing to pay $50 when three advertisement slots are presented. Thus, advertiser A values allocation of an advertisement slot equally when one or two advertisement slots are presented. However, the value to advertiser A of an advertisement slot is less when a third advertisement slot is presented.

Advertiser B only values allocation of an advertisement slot when two advertisement slots are presented, as indicated by the bids of $0 for advertisement slots in the advertisement configurations in which one or three advertisement slots are presented. Meanwhile, advertisers C and D place some value on allocation of advertisement slots in any of the advertisement slot configurations.

Based on the bids received from the advertisers 102, the auction subsystem 116 can identify an optimal advertisement configuration. For example, the auction subsystem 116 can sum the highest n bids for each advertisement slot configuration, where n is an integer of 1 or greater that represents the number of advertisement slots available in the advertisement slot configuration. Because the bids for advertisement slots are an indication of the relative value of the advertisement slots to advertisers, the advertisement slot configuration for which the sum of the n-highest bids is greatest provides the highest cumulative value to the advertisers that are allocated advertisement slots in that advertisement slot configuration.

Continuing with the example above, for each of the one slot, two slot and three slot configurations, the auction subsystem 116 can sum the top n bids for each of advertisement slot configurations to determine the relative value of the advertisement slot configurations to the advertisers, n being equal to the number of available advertisement slots. The highest n bids and the relative values of each of the advertisement slot configurations are provided in Table 2.

TABLE 2

| | One Slot | Two Slot | Three Slot |
|---|---|---|---|
| | Configuration | Configuration | Configuration |
| Advertiser A | $152 | $100 | $50 |
| Advertiser B | | $50 | |
| Advertiser C | | | $15 |
| Advertiser D | | | $10 |
| Relative Value | $152 | $150. | $75 |
| (Sum of n highest | | | |
| bids) | | | |

In this example, the one slot advertisement configuration has the highest relative value to the advertisers based on the bids provided for advertisement slots in each of the advertisement configurations. Therefore, the auction subsystem 116 can provide data to the publisher 106 and the advertisement management system 104 identifying the one slot configuration as the advertisement slot configuration in which advertisements provided by the advertisement management system 104 will be presented. In turn, the advertisement management system 104 can provide the advertisements for advertiser A to the publisher 106 or to the user device 108 for presentation in the advertisement slot.

In some implementations, the advertisement slots of a selected advertisement slot configuration can be ranked and allocated based on their respective ranks. In some implementations, the advertisement slots are ranked, for example, based on a historical performance of advertisements that are presented in each of the advertisement slots in the advertisement slot configuration. The historical performance of advertisements that are presented in the advertisement slots can be measured based on the CTR, number of impressions, number of conversions, or other performance metrics of the advertisements.

For example, a CTR of advertisements presented in the advertisement slots 202, 204 and 206 of advertisement slot configuration 201 can be monitored over a period of time so that a statistically relevant number of impressions and clicks are received for advertisements in each of the advertisement slots. In turn, the advertisement slots 202, 204 and 206 can be ranked based on their respective click-through rates (e.g., in descending order of click-through rates).

The auction subsystem 116 can allocate the ranked advertisement slots to the advertisers 102 based on the bids that are received from the advertisers 102. For example, the auction subsystem 116 can allocate the highest ranked advertisement slot (e.g., having the highest click-through rate) to the advertiser 102 from which the highest bid was received. Similarly, the auction subsystem 116 can allocate the second highest advertisement slot to the advertiser 102 from which the second highest bid was received. The auction subsystem 116 can continue allocating advertisement slots in descending order of rank to the advertisers 102 in descending order of bid until each of the n advertisement slots has been allocated to an advertiser 102 from which one of the top n bids was received.

### §2.2 Pricing Advertisement Slots in an Optimal Configuration

Once advertisement slots for the optimal advertisement slot configuration have been allocated, the price that each advertiser 102 pays for allocation of the advertisement slot is determined by the auction subsystem 116. In some implementations, the auction subsystem 116 determines a minimum pay property for each advertiser 102 that is allocated an advertisement slot in the optimal advertisement slot configuration. The minimum pay property for each advertiser 102 is the minimum price that the advertiser 102 must bid to maintain its allocation of an advertisement slot in the optimal advertisement slot configuration. The minimum pay property for an advertiser 102 is determined based on the bids that are received from the advertisers 102 for advertisement slots in each of the advertisement slot configurations.

Continuing with the example above, as discussed, the relative value of the one slot configuration is $152 based on the maximum bid received from advertiser A and the relative value of the two slot configuration is $150 based on the maximum bids received from advertisers A and B. However, if the bid by advertiser A for the advertisement slot in the one slot configuration is lowered to $149, then the relative value of one slot configuration becomes $149. The reduced bid by advertiser A results in the two slot configuration being the optimal advertisement slot configuration having a relative value of $150 when advertiser A and B each bid their respective maximum bids for advertisement slots in the two slot configuration. The minimum pay property for advertiser A in the one slot configuration is thus an incremental amount (e.g., one cent, one dollar, etc.) greater than $150 (e.g., $150.01, $151, etc.) in order to maintain the current advertisement slot allocation in the current optimal advertisement slot configuration. The incremental amount can be specified by the auction subsystem 116.

The auction subsystem 116 can determine the minimum pay property for each advertiser 102 that is allocated an advertisement slot in the optimal advertisement slot configuration. The auction subsystem 116 determines minimum pay properties such that the optimal advertisement slot configuration does not change. The auction subsystem 116 can also determine minimum pay properties such that each advertisement slot in the optimal advertisement slot configuration remains allocated to the same advertiser 102 that the advertisement slot is allocated to based on the maximum bids. In some implementations, the auction subsystem 116 determines the minimum pay property for each advertiser 102 by determining a minimum price that satisfies minimum pay property constraints, as described below.

In some implementations, the auction subsystem 116 requires that the minimum pay property for each advertiser that is allocated an advertisement slot in the optimal advertisement slot configuration (Cₖ) be greater than the next highest bid that was received for an advertisement slot in the optimal configuration. This minimum pay property constraint ensures that each advertisement slot in the optimal configuration remains allocated to the same advertiser 102 to which the advertisement slot was allocated to based on the maximum bids. For example, if the advertiser for which the minimum pay property is being determined provided a bid of $50 and the next highest bid received from an advertiser was $45, the auction subsystem 116 will not set the minimum pay property for the advertiser at less than $45 plus the incremental value.

The auction subsystem 116 can also apply minimum pay property constraints to the minimum pay property for the advertiser that operate to maintain the optimal advertisement slot configuration. These minimum pay property constraints can maintain a value of the optimal advertisement slot configuration at a value greater than the maximum value of other available advertisement slot configurations.

An example illustrating determination of minimum pay properties for advertisers that are allocated advertisement slots in an example optimal configuration (Cₖ) is provided below. The example is based on a single bid for each advertiser that is valid for each configuration in which the advertiser is competing for an advertisement slot. Minimum pay properties for advertisers that are allocated advertisement slots in other advertisement slot configurations and/or from which independent bids are valid for each of the advertisement slot configurations can also be determined. These minimum pay properties can be based on other minimum pay property constraints that are defined based on the particular configuration and/or the bids that are provided by the advertisers.

For each advertiser (i) that is allocated an advertisement slot in the example optimal configuration Cₖ, the auction subsystem 116 defines an exclusive range of advertisement slot configurations C_{αi}, . . . , C_{βi} in which the advertiser is allocated an advertisement slot in each of the advertisement configurations.

Where,

1≦αi≦k≦βi≦X; and

X is the number of available advertisement slot configurations.

For example, a particular webpage can include an advertisement slot configuration in which one to five advertisement slots are selectively presented. The auction subsystem 116 will define X=5 for this webpage because five different advertisement slot configurations (e.g., C₁-C₅) are available for the webpage.

Assume for this example, that an advertiser has submitted bids for the advertisement slot configurations C₂-C₄ in which two to four advertisement slots are presented. Also, assume that the bids provided by the advertiser are in the top n bids provided for an advertisement slot in each of the advertisement slot configurations. Finally, assume that the auction subsystem 116 has identified the advertisement slot configuration in which three advertisement slots are presented on the webpage as the optimal advertisement slot configuration (e.g., k=3; Cₖ=C₃). In this example, the auction subsystem 116 defines αi=2 and βi=4 because the advertiser will appear in advertisement slots that include between two and four advertisement slots. Thus, the advertiser will be allocated an advertisement slot in each of the advertisement slot configurations from C₂-C₄.

The auction subsystem 116 groups the available advertisement slot configurations into three configuration groups. A first configuration group includes the advertisement slot configurations Cₖ₊₁ to C_{βi}. A second configuration group includes the advertisement slot configurations C_{d} where d>βi and d<αi. A third configuration group includes the advertisement slot configurations C_{αi} to Cₖ₋₁. Each of the three configuration groups has properties that constrain the minimum pay property for the advertiser so that the optimal configuration Cₖ and the advertisement slot allocations are not changed due to the minimum pay property.

The auction subsystem 116 defines the first configuration group to include the advertisement slot configurations from Cₖ₊₁ to C_{βi}. The auction subsystem 116 requires that the minimum pay property for the advertiser be greater than the next highest maximum bid received from an advertiser for an advertisement slot in each of the advertisement slot configurations Cₖ₊₁ to C_{βi} and that the next highest bidder in Cₖ₊₁ to C_{βi} have a bid that is less than the next highest bid in the optimal configuration (Cₖ). This minimum pay property constraint is represented by the relationship (1):

Pₘₚₚ>bᵥₖ>b_{vd} (1)

Where,

Pₘₚₚ is the minimum pay property of the advertiser;

Bᵥₖ is the next highest maximum bid in the optimal configuration; and

B_{vd} is the next highest maximum bid in an advertisement slot configuration d, where d is selected from Cₖ₊₁ to C_{βi}.

This minimum pay property constraint maintains the cumulative value of the optimal advertisement slot configuration (Cₖ) at a value that exceeds the maximum cumulative value of any of the advertisement slot configurations Cₖ₊₁ to C_{βi} in the first configuration group. This minimum pay property constraint also prevents any of the advertisement slots from being allocated to an advertiser other than the advertiser to which the advertisement slot was allocated based on the maximum bids because the bid by the advertiser does not fall below the next highest bid received from another advertiser.

The auction subsystem 116 defines a second configuration group that includes advertisement slot configurations C_{d} where d>βi and d<αi. These are advertisement slot configurations in which the advertiser is not allocated an advertisement slot. The auction subsystem 116 requires that the minimum pay property for the advertiser be greater than a maximum difference between the maximum values of each of the advertisement slot configurations C_{d} (where d>βi and d<αi) and the maximum value of the optimal advertisement slot configuration Cₖ without the advertiser's bid, which is represented by the relationship (2):

Pₘₚₚ>max_{d}{V(C_{d})−(V(Cₖ)−bᵢ} (2)

Where,

Pₘₚₚ is the minimum pay property;

V(C_{d}) is the maximum value of an advertisement configuration d;

d is defined by the inequalities d<αi and βi<d;

V(Cₖ) is the maximum value of the optimal advertisement configuration Cₖ; and

bᵢ is the maximum bid of the advertiser to which the advertisement slot is allocated.

This minimum pay property constraint prevents a configuration in which the advertiser is not allocated an advertisement slot from having a maximum cumulative value that is greater than the cumulative value of the optimal advertisement configuration at the Pₘₚₚ prices. Therefore, the optimal advertisement configuration will not change when the advertiser is charged the minimum pay property for allocation of an advertisement slot in the optimal advertisement slot configuration.

The auction subsystem 116 defines a third configuration group that includes the advertisement slot configurations from C_{αi} to Cₖ₋₁. The auction subsystem 116 requires that the value of the optimal advertisement slot configuration Cₖ when the advertiser pays the minimum pay property be greater than the value of the advertisement slot configurations C_{αi} to Cₖ₋₁ when the advertiser pays the minimum pay property. This requirement is represented by the relationship (3):

V(C_{d})−bᵢ+Pₘₚₚ<V(Cₖ)−bᵢ+Pₘₚₚ (3)

Where,

V(C_{d}) is the maximum value of the advertisement slot configuration d;

αi≦d≦k−1;

bᵢ is the maximum bid of the advertiser; and

Pₘₚₚ is the minimum pay property for the advertiser to which the advertisement slot is allocated.

If the above relationship (3) is not satisfied, the auction subsystem 116 can constrain the minimum pay property for the advertiser based on the relationship (4):

Pₘₚₚ>=max_{d}{V(C_{-d})−bᵢ} (4)

Where,

Pₘₚₚ is the minimum pay property for the advertiser;

V(C_{-d}) is the value of the advertisement configuration d when the advertiser is not allocated an advertisement slot in the advertisement slot configuration d;

αi≦d≦k−1; and

bᵢ is the maximum bid provided by the advertiser in the optimal configuration.

This minimum pay property constraint prevents the minimum pay property from being a price that is below the next highest bid that was received for an advertisement slot in the advertisement slot configuration. Therefore, the advertisement slot remains allocated to the same advertiser 102 and the optimal configuration remains the same.

The auction subsystem 116 determines a lower bound for the minimum pay property to be the price for the advertisement slot that does not violate any of the above minimum pay property constraints. Therefore, the auction subsystem 116 can base the minimum pay property on the maximum of the prices that are computed based on the constraints of the second configuration group and the third configuration group. The auction subsystem 116 can add an incremental amount (e.g., 1 cent, 1 dollar or another predefined incremental amount) to the maximum of the prices computed above and assign this price plus the incremental amount as the minimum pay property for the advertiser 102.

The auction subsystem 116 iteratively determines the minimum pay property for each of the advertisers 102 that are allocated advertisement slots in the optimal configuration until each advertiser's minimum pay property has been determined. The auction subsystem 116 can provide the minimum pay property to the advertisement management system 104 that can, in turn, charge the advertiser a price for the advertisement slot based on the minimum pay property.

### §3.0 Example Process Flows

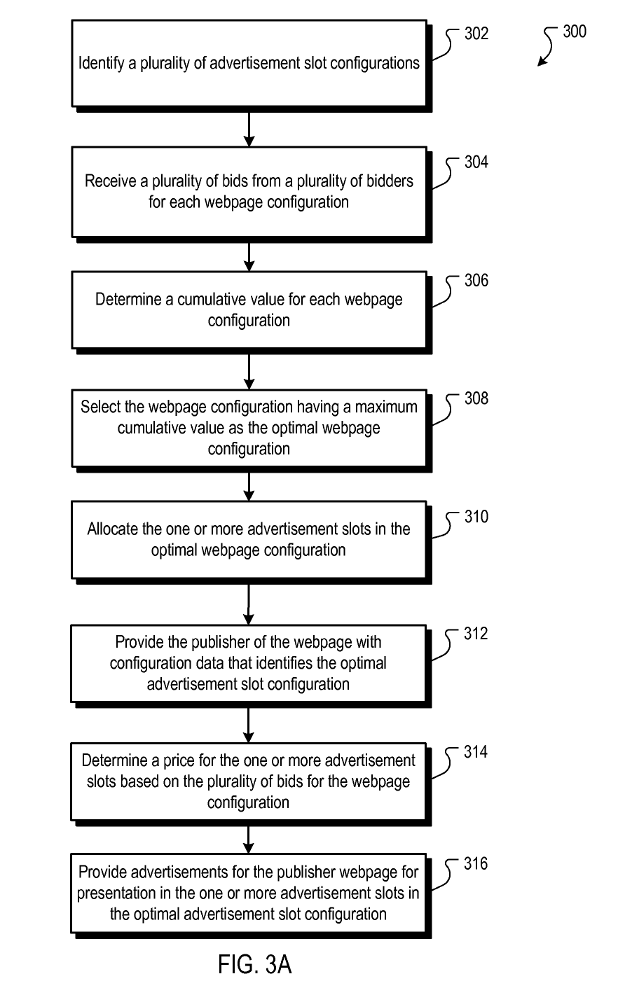

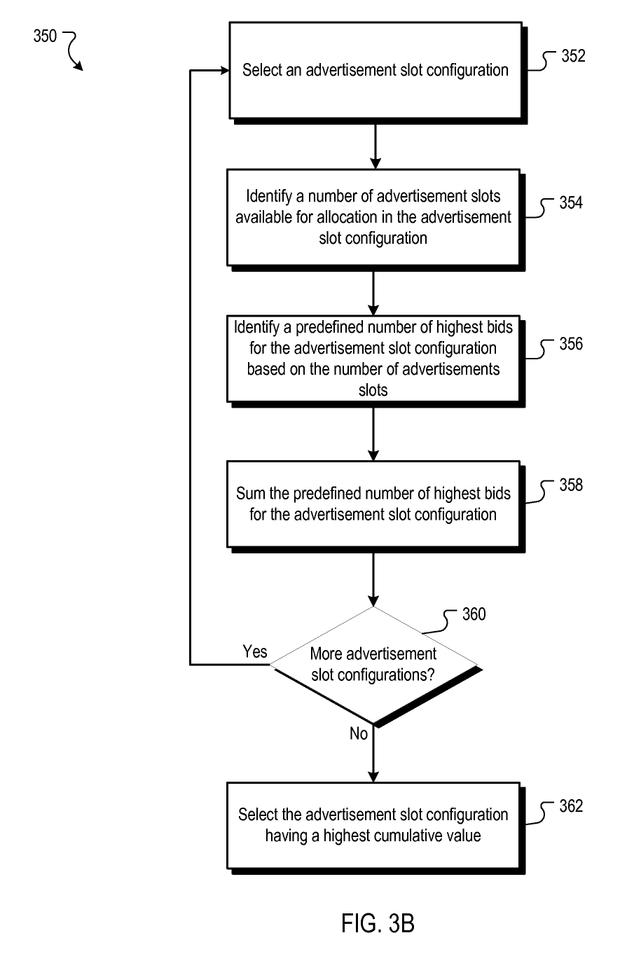

FIG. 3A is a flow chart of an example process 300 for allocating slots in an optimal slot configuration. The process 300 can be implemented, for example, by the auction subsystem 116 and/or the advertisement management system 104 of FIG. 1. In some implementations, the slots are advertisement slots and the optimal slot configuration is an optimal advertisement slot configuration. Advertisement slots are presented, for example, on publishers' web properties, advertisements spots in print media or other advertising mediums. While the process 300 is described with reference to allocating advertisement slots, the process can also be used to distribute other forms of content.

A plurality of advertisement slot configurations are identified (302). In some implementations, each advertisement slot configuration includes one or more advertisement slots for a webpage. The advertisement slot configuration can define a number of advertisement slots that are defined in the webpage. The advertisement slot configuration can also define an orientation of advertisement slots for the webpage. The advertisement slot configuration can further define an advertisement type that is eligible to have a corresponding bid for the advertisement slots in the corresponding advertisement slot configuration.

The plurality of advertisement slot configurations can be identified, for example, based on advertisement slot configuration data that is received from the publisher that provides the webpage in which the advertisement slots are defined. The plurality of advertisement slot configurations can be identified, for example, by the auction subsystem 116.

A plurality of bids for each advertisement slot configuration are received from a plurality of bidders (304). In some implementations, each bid specifies a maximum amount that a bidder will bid for allocation of advertisement slot in the advertisement slot configuration. Each bid can also specify the corresponding advertisement slot configuration for which it is valid. The plurality of bids can be received, for example, by the auction subsystem 116.

A cumulative value is determined for each advertisement slot configuration (306). In some implementations, the cumulative value of an advertisement slot configuration can be determined based on the plurality of bids for the advertisement slot configuration. For example, the cumulative value of an advertisement slot configuration can be the sum of the highest n bids received for advertisement slots in the advertisement slot configuration, where n is the number of advertisement slots available in the advertisement slot configuration. The cumulative value can be determined, for example, by the auction subsystem 116.

The advertisement slot configuration having a maximum cumulative value is selected as the optimal advertisement slot configuration (308). In some implementations, the advertisement slot configuration having the maximum cumulative value is determined by comparing the maximum cumulative value of each advertisement slot configuration that is available for the webpage. The advertisement slot configuration having a maximum cumulative value can be selected, for example, by the auction subsystem 116.

The one or more advertisement slots in the optimal advertisement slot configuration are allocated (310). In some implementation, the one or more advertisement slots are allocated based on the plurality of bids for the advertisement slot configuration. For example, the one or more advertisement slots can be allocated to the highest n bidders, where n is the number of advertisement slots available in the optimal advertisement slot configuration. The one or more advertisement slots can be allocated, for example, by the auction subsystem 116.

The publisher of the webpage is provided with configuration data that identifies the optimal advertisement slot configuration (312). In some implementations, the configuration data can specify a number of advertisement slots and/or an orientation of the advertisement slots in the optimal advertisement slot configuration. The configuration data can be provided, for example, by the auction subsystem 116.

While the configuration data is described as being provided to the publisher for example purposes, the configuration data can also be provided to a user device in the form of JavaScript of some other script format. In turn, the user device can execute the script to format the advertisement slots in accordance with the optimal advertisement slot configuration.

A price for the one or more advertisement slots is determined based on the plurality of bids for the advertisement slot configuration (314). In some implementations, the price for each advertisement slot can be a minimum pay property for the advertiser does allocated the advertisement slot. The minimum pay property is the minimum price that the advertiser must bid to maintain the allocation of advertisement slot and prevent the cumulative value of the optimal configuration from being less than the cumulative value of another configuration. The price for the one or more advertisement slots can be determined, for example, by the auction subsystem 116.

Advertisements are provided for the publisher webpage for presentation in the one or more advertisement slots in the optimal advertisement slot configuration (316). The advertisements that are provided to the publisher are the advertisements for the advertisers from which the highest n bids were received, where n is the number of advertisement slots that are available in the optimal advertisement slot configuration. The advertisement can be provided, for example, by the advertisement management system 104.

FIG. 3B is a flow chart of an example process 350 of determining the cumulative value for each slot configuration. The process 350 is described with reference to advertisement slots. However, the process 350 can be performed for other content environments. The process 350 can be implemented, for example, by the auction subsystem 116 and/or the advertisement management system 104 of FIG. 1. Determination of the cumulative value for a single advertisement slot configuration is discussed below. However, the example process 350 can be iteratively performed to determine the cumulative value for each advertisement slot configuration.

An advertisement slot configuration is selected (352). The advertisement slot configuration can be selected, for example, based on the advertisement slot configuration data that is provided by a publisher for a webpage. The advertisement slot configuration can be selected, for example, by the auction subsystem 116.

A number of advertisement slots that are available for allocation in the advertisement slot configuration is identified (354). In some implementations, the number of advertisement slots that are available for allocation in the advertisement slot configuration is received from the publisher of the webpage. A number of advertisement slots can be identified, for example, by the auction subsystem 116 and/or the advertisement management system 104.

A predefined number of highest bids for the advertisement slot configuration are identified based on the number of advertisement slots (356). In some implementations, the predefined number of highest bids is set equal to an integer number of advertisement slots that are available in the advertisement slot configuration. The predefined number of highest bids can be identified, for example, by the auction subsystem 116.

The predefined number of highest bids for the advertisement slot configuration are summed (358). In some implementations, the sum of the predefined number of highest bids represents the cumulative value for the advertisement slot configuration. The predefined number of highest bids can be summed, for example, by the auction subsystem 116.

A determination of whether more advertisement slot configurations are available is made (360). In some implementations, the determination can be made based on whether all of the advertisement slot configurations defined in the advertisement slot configuration data has been selected. The determination can be made, for example, by the auction subsystem 116.

If more advertisement slot configurations are available, another advertisement slot configuration is selected (352). If no more advertisement slot configurations are available, the advertisement slot configuration having a highest cumulative value is selected (362). The selection can be performed, for example, by the auction subsystem 116.

### §4.0 Example Computer System

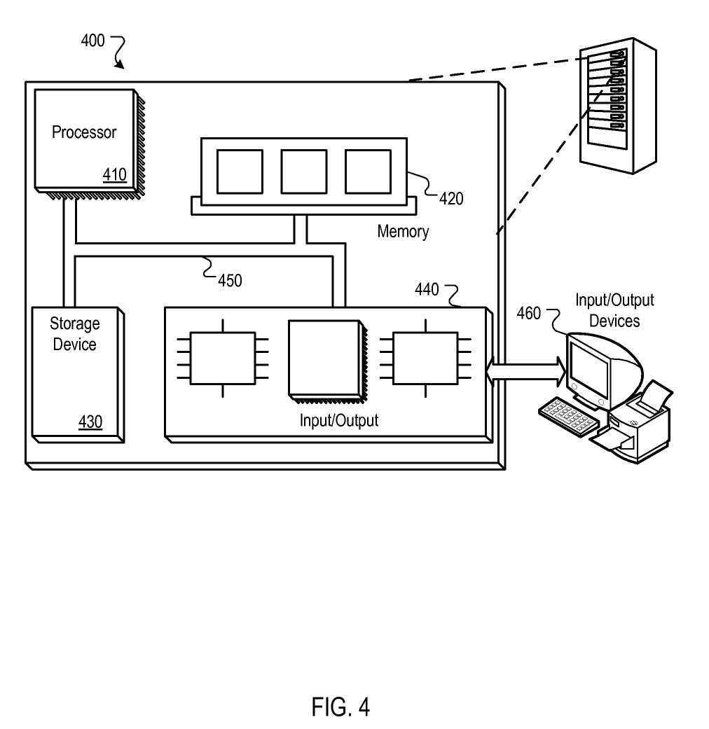

FIG. 4 is block diagram of an example computer system 400 that can be used to facilitate allocation of advertisement slots in an optimal advertisement slot configuration. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, or some other large capacity storage device.

The input/output device 440 provides input/output operations for the system 400. In one implementation, the input/output device 440 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 460. Other implementations, however, can also be used, such as mobile computing devices, mobile communication devices, set-top box television client devices, etc.

The auction subsystem 116 and/or advertisement management system 104 can be realized by instructions that upon execution cause one or more processing devices to carry out the processes and functions described above. Such instructions can comprise, for example, interpreted instructions, such as script instructions, e.g., JavaScript or ECMAScript instructions, or executable code, or other instructions stored in a computer readable medium. The auction subsystem 116 and/or advertisement management system 104 can be distributively implemented over a network, such as a server farm, or can be implemented in a single computer device.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible program carrier for execution by, or to control the operation of, a processing system. The computer readable medium can be a machine readable storage device, a machine readable storage substrate, a memory device, a composition of matter effecting a machine readable propagated signal, or a combination of one or more of them.

The term “processing system,” “processing devices” and “subsystem” encompasses all apparatus, devices, and machines for processing data, including by way of example a programmable processor, a computer, or multiple processors or computers. The processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

Implementations of the subject matter and the functional operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible program carrier for execution by, or to control the operation of, data processing apparatus.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. While reference is made to delivering advertisements, other forms of content including other forms of sponsored content can be delivered.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art may effect alterations, modifications and variations to the examples without departing from the scope of the invention.

What is claimed is:

1. A computer-implemented method, comprising:
identifying a plurality of slot configurations for a publication provided by a publisher, each slot configuration comprising one or more slots;
receiving a plurality of bids from a plurality of bidders for each slot configuration, each bid specifying a maximum amount that a bidder will pay for allocation of a slot in the corresponding slot configuration;
determining a cumulative value for each slot configuration based on the plurality of bids;
selecting the slot configuration having a maximum cumulative value as the optimal slot configuration; and
allocating the one or more slots in the optimal slot configuration to the bidders based on the plurality of bids for the optimal slot configuration.

2. The method of claim 1, wherein a slot comprises an advertisement slot and a slot configuration comprises an advertisement slot configuration.

3. The method of claim 2, wherein each advertisement slot configuration defines an advertisement type that is eligible to have a corresponding bid for the advertisement slots.

4. The method of claim 1, wherein each slot configuration defines a unique number of slots.

5. The method of claim 1, wherein each slot configuration defines a unique orientation of slots.

6. The method of claim 1, wherein determining the cumulative value for each slot configuration comprises:
for each slot configuration:
identifying a number of slots available for allocation in the slot configuration;
identifying a number of highest bids for the slot configuration based on the number of slots; and
summing the number of highest bids for the slot configuration.

7. The method of claim 6, wherein the number of highest bids is a number of slots available.

8. The method of claim 1, further comprising determining a price for the one or more slots based on the plurality of bids for the slot configuration.

9. The method of claim 8, wherein determining a price for the one or more slots comprises determining a minimum pay property for each bidder that is allocated each of the one or more slots, the minimum pay property being a minimum price that the bidder must bid to maintain the allocation of the one or more slots to the bidders.

10. The method of claim 1, further comprising providing content to the publisher for presentation in the one or more slots in the optimal slot configuration.

11. The method of claim 10, wherein the content provided to the publisher comprise advertisements for bidders that provided a predefined number of highest bids, the predefined number being based on a number of slots available in the optimal slot configuration.

12. A system, comprising:
an advertisement management system comprising one or more processors to receive advertisement information data from advertisers and advertisement slot configuration data from publishers, the advertisement information data specifying advertisements for presentation in advertisement slots and bids specifying a maximum amounts that advertisers will pay for presentation of the advertisement, the advertisement slot configuration data specifying a configuration of advertisement slots that are available on publishers' properties for presentation of advertisements;
a data store coupled to the advertisement management system to store the advertisement information data and the advertisement slot configuration data; and
an auction subsystem coupled to the advertisement management system and the data store, the auction subsystem operable to identify an optimal advertisement slot configuration for a publisher's property based on the bids, the optimal advertisement slot configuration being an advertisement slot configuration that maximizes a cumulative value of the advertisement slots.

13. The system of claim 12, wherein the advertisement slot configuration defines a unique number of advertisement slots that are presented on a webpage.

14. The system of claim 12, wherein the advertisement slot configuration defines a unique orientation of advertisement slots that are presented on a webpage.

15. The system of claim 12, wherein the advertisement slot configuration defines an advertisement type of an advertisement that is eligible to have a corresponding bid for the advertisement slots.

16. The system of claim 12, wherein the auction subsystem is configured to allocate advertisement slots in the advertisement slot configuration based on the bids.

17. The system of claim 12, wherein the auction subsystem is configured to determine a minimum pay property for an advertiser that is allocated an advertisement slot, the minimum pay property being a minimum price that the advertiser must bid to maintain a bid-based allocation of advertisement slots to advertisers in the optimal advertisement slot configuration.

18. The system of claim 17, wherein the minimum pay property is defined by minimum pay property constraints, the minimum pay property constraints comprising:
a first minimum pay property constraint that maintains the cumulative value of the optimal advertisement slot configuration at a value that is greater than the maximum cumulative value of other advertisement slot configurations;
a second minimum pay property constraint that prevents advertisement slot configurations in which the advertiser is not allocated an advertisement slot from having a maximum cumulative value that is greater than the cumulative value of the optimal advertisement slot configuration; and
a third minimum pay property that prevents the minimum pay property from being a price less than a next highest bid that was received for an advertisement slot in the optimal advertisement slot configuration.

19. The system of claim 12, wherein the cumulative value of the advertisement slots in an advertisement slot configuration is based on a number of highest bids received for advertisement slots in the advertisement slot configuration, the number of highest bids corresponding to a number of advertisement slots in the advertisement slot configuration.

20. The system of claim 19, wherein the cumulative value of the advertisement slots in the advertisement slot configuration is a sum of the number of highest bids.

21. The system of claim 12, wherein the advertisement management system is configured to identify advertisements for presentation in the advertisement slots of the optimal advertisement slot configuration and provide the advertisements to the publisher.
